(19) United States
(12) Patent Application Publication
(10) Pub. No.: US 2012/0215442 A1
(43) Pub. Date: Aug. 23, 2012

(54) POSITIONING APPARATUS, POSITIONING METHOD, AND STORAGE MEDIUM FOR MEASURING POSITION USING BOTH AUTONOMOUS NAVIGATION AND GPS

(75) Inventor: Masao SAMBONGI, Tokyo (JP)

(73) Assignee: CASIO COMPUTER CO., LTD., Tokyo (JP)

(21) Appl. No.: 13/396,917

(22) Filed: Feb. 15, 2012

(30) Foreign Application Priority Data
Feb. 18, 2011 (JP) 2011-032830

(51) Int. Cl. G01C 21/12

(52) U.S. Cl. 701/472

(57) ABSTRACT

A positioning apparatus determines a registered point to be a current absolute position in the case where the apparatus determines that a current estimated position of the apparatus, which is calculated from an intermittently-measured absolute position and continuously-acquired relative position data, is within a predetermined distance of the beforehand-registered point; and determines that the apparatus is in a predetermined state indicating that the apparatus is likely to arrive at the registered point.

### BACKGROUND OF THE INVENTION

1. Field of the Invention

The present invention relates to a positioning apparatus, a positioning method, and a storage medium having recorded thereon a computer program for the method.

2. Description of Related Art

There has been an apparatus which determines and stores a series of position data corresponding to positions on a travelling path, on the basis of both absolute positions and relative displacements. The absolute positions are measured with a Global Navigation Satellite System (GNSS), while the relative displacements are measured with autonomous navigation using a motion sensor including an acceleration sensor and a magnetic sensor.

Such an apparatus displays the series of position data as a moving route on a map image.

Such an apparatus requires relatively large power for receiving signals from positioning satellites. Thus, some apparatuses intermittently measure the absolute position with the positioning satellites to reduce power consumption while continuously performing positioning with the autonomous navigation.

The data of the intermittently-measured absolute position are used as the position data of reference points in autonomous navigation positioning.

The data of the absolute position are also used for later correction of errors that are gradually accumulated as the results of the autonomous navigation positioning.

Japanese Patent Application Laid-Open Publication No. 11-194033, relevant to the present invention, discloses a technique of correcting parameters which are used for autonomous navigation positioning of a walking body, and correcting the results of the positioning, by using the results of the global positioning system (GPS) positioning.

### SUMMARY OF THE INVENTION

An object of the present invention is to provide a positioning apparatus, a positioning method, and a storage medium having recorded thereon a computer program for the method, which can acquire a result of positioning reflecting accurate position data of a predetermined point when the apparatus moves to or through the predetermined point.

According to an aspect of the present invention, there is provided a positioning apparatus including: a first positioning unit that acquires first absolute position data by receiving signals from positioning satellites at predetermined time intervals to measure a current position of the positioning apparatus; a second positioning unit that continuously detects a movement and a traveling direction of the positioning apparatus, and acquires relative position data based on the movement and the traveling direction; a position calculation unit that calculates a current estimated position of the positioning apparatus based on the first absolute position data and the relative position data; a point registration unit that registers a point as second absolute position data; a distance determination unit that determines whether the estimated position calculated by the position calculation unit is within a predetermined distance of the point registered by the point registration unit; an arrival determination unit that determines whether the positioning apparatus is in a predetermined state, the predetermined state indicating that the positioning apparatus is likely to arrive at the registered point; and a current-position determination unit that determines the second absolute position data to be current absolute position data when the distance determination unit determines that the estimated position is within the predetermined distance of the registered point and when the arrival determination unit determines that the positioning apparatus is in the predetermined state.

According to another aspect of the present invention, there is provided a positioning apparatus including: a first positioning unit that acquires first absolute position data by receiving signals from positioning satellites at predetermined time intervals to measure a current position of the positioning apparatus; a second positioning unit that continuously detects a movement and a traveling direction of the positioning apparatus, and acquires relative position data based on the movement and the traveling direction; a positioning control unit that allows the first positioning unit to acquire the first absolute position data, and allows the second positioning unit to acquire the relative position data; a position calculation unit that calculates a current estimated position of the positioning apparatus based on the first absolute position data and the relative position data; a point registration unit that registers a point; a distance determination unit that determines whether the estimated position calculated by the position calculation unit is within a predetermined distance of the point registered by the point registration unit,

wherein the positioning control unit allows the first positioning unit to acquire the first absolute position data when the distance determination unit determines that the estimated position is within the predetermined distance.

According to another aspect of the present invention, there is provided a positioning method using a first positioning unit and a second positioning unit, the first positioning unit acquiring first absolute position data by receiving signals from positioning satellites at predetermined time intervals to measure a current position of a positioning apparatus, and the second positioning unit continuously detecting a movement and a traveling direction of the positioning apparatus to acquire relative position data based on the movement and the traveling direction, the method including: (a) calculating a current estimated position of the positioning apparatus based on the first absolute position data and the relative position data; (b) registering a point as second absolute position data; (c) determining whether the estimated position calculated by step (a) is within a predetermined distance of the point registered by step (b); (d) determining whether the positioning apparatus is in a predetermined state, the predetermined state indicating that the positioning apparatus is likely to arrive at the registered point; and (e) determining the second absolute position data to be current absolute position data when step (c) determines that the estimated position is within the predetermined distance of the registered point and when step (d) determines that the positioning apparatus is in the predetermined state.

According to another aspect of the present invention, there is provided a positioning method using a first positioning unit and a second positioning unit, the first positioning unit acquiring first absolute position data by receiving signals from positioning satellites at predetermined time intervals to measure a current position of a positioning apparatus, and the second positioning unit continuously detecting a movement and a traveling direction of the positioning apparatus to acquire relative position data based on the movement and the traveling direction, the method including: (a) allowing the first positioning unit to acquire the first absolute position data, and allowing the second positioning unit to acquire the relative position data; (b) calculating a current estimated position of the positioning apparatus based on the first absolute position data and the relative position data; (c) registering a point; (d) determining whether the estimated position calculated by step (b) is within a predetermined distance of the point registered by step (c), wherein the positioning control unit allows the first positioning unit to acquire the first absolute position data when step (d) determines that the estimated position is within the predetermined distance.

According to another aspect of the present invention, there is provided a computer readable storage medium having recorded thereon a computer program for controlling a computer which controls a first positioning unit and a second positioning unit, the first positioning unit acquiring first absolute position data by receiving signals from positioning satellites at predetermined time intervals to measure a current position of a positioning apparatus, and the second positioning unit continuously detecting a movement and a traveling direction of the positioning apparatus to acquire relative position data based on the movement and the traveling direction, wherein the program controls the computer to function as: a position calculation unit that calculates a current estimated position of the positioning apparatus based on the first absolute position data and the relative position data; a point registration unit that registers a point as second absolute position data; a distance determination unit that determines whether the estimated position calculated by the position calculation unit is within a predetermined distance of the point registered by the point registration unit; an arrival determination unit that determines whether the positioning apparatus is in a predetermined state, the predetermined state indicating that the positioning apparatus is likely to arrive at the registered point; and a current-position determination unit that determines the second absolute position data to be current absolute position data when the distance determination unit determines that the estimated position is within the predetermined distance of the registered point and when the arrival determination unit determines that the positioning apparatus is in the predetermined state.

According to another aspect of the present invention, there is provided a computer readable storage medium having recorded thereon a computer program for controlling a computer which controls a first positioning unit and a second positioning unit, the first positioning unit acquiring first absolute position data by receiving signals from positioning satellites at predetermined time intervals to measure a current position of a positioning apparatus, and the second positioning unit continuously detecting a movement and a traveling direction of the positioning apparatus to acquire relative position data based on the movement and the traveling direction, wherein the program controls the computer to function as: a positioning control unit that allows the first positioning unit to acquire the first absolute position data, and allows the second positioning unit to acquire the relative position data; a position calculation unit that calculates a current estimated position of the positioning apparatus based on the first absolute position data and the relative position data; a point registration unit that registers a point; a distance determination unit that determines whether the estimated position calculated by the position calculation unit is within a predetermined distance of the point registered by the point registration unit, wherein the program further controls the computer so that the positioning control unit allows the first positioning unit to acquire the first absolute position data when the distance determination unit determines that the estimated position is within the predetermined distance.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a block diagram illustrating the overall configuration of a positioning apparatus according to an embodiment of the present invention;

FIG. 2 illustrates an example of recording of a moving route along a path from a station to home;

FIG. 3 is a flow chart illustrating a control process of positioning to be performed by a CPU according to a first embodiment;

FIG. 4 is a flow chart illustrating a control process of positioning to be performed by the CPU according to a second embodiment;

FIG. 5 is a flow chart illustrating a control process of positioning to be performed by the CPU according to a third embodiment; and

FIG. 6 is a flow chart illustrating a control process of positioning to be performed by the CPU according to a fourth embodiment.

### DESCRIPTION OF THE PREFERRED EMBODIMENTS

Embodiments of the present invention will be described with reference to the accompanying drawings.

### First Embodiment

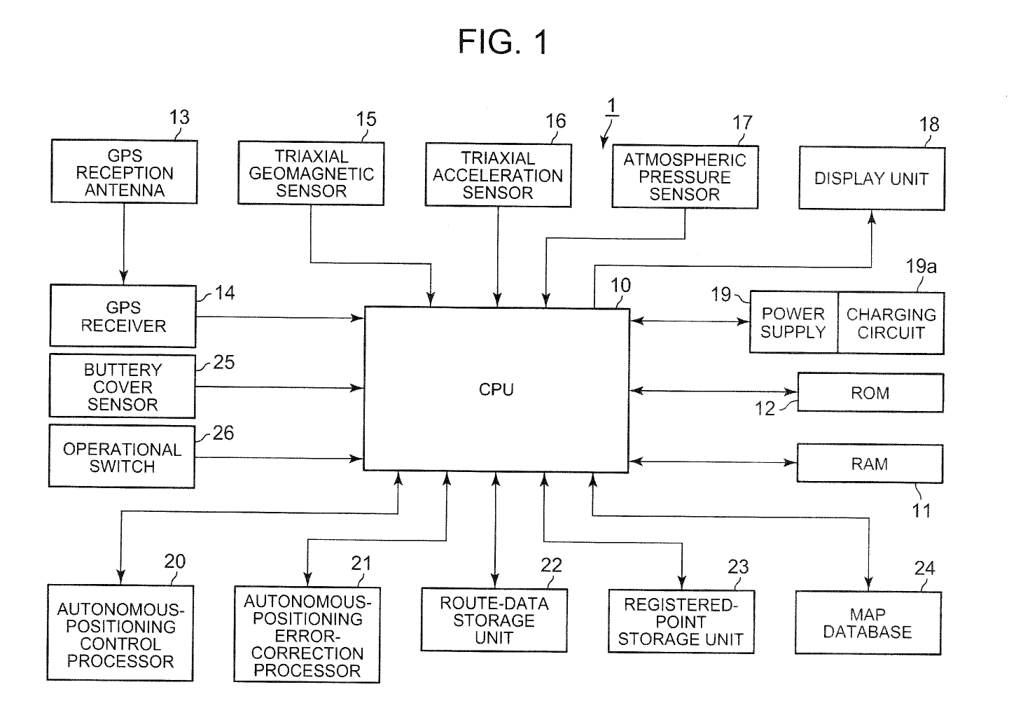

FIG. 1 is a block diagram illustrating a positioning apparatus 1 according to a first embodiment of the present invention.

The positioning apparatus 1 of this embodiment records a series of position data corresponding to a travelling path as route data, by measuring positions while the positioning apparatus 1 is moving along the travelling path.

The positioning apparatus 1 displays the route on a map image.

The positioning apparatus 1 performs autonomous navigation positioning (hereinafter, referred to as autonomous positioning) in correspondence to, but not limited to, walking of a user.

As illustrated in FIG. 1, the positioning apparatus 1 includes a central processing unit (CPU) 10 comprehensively controlling the entire apparatus; a random access memory (RAM) 11 providing a work space for the CPU 10; a read only memory (ROM) 12 holding control programs to be executed by the CPU 10 and control data; a global positioning system (GPS) reception antenna 13 and a GPS receiver 14 receiving signals or data from GPS satellites; a triaxial geomagnetic sensor 15 and a triaxial acceleration sensor 16, which constitute an autonomous navigation motion sensor; an atmospheric pressure sensor 17 for detecting movement in a height direction; a display unit 18 displaying various types of data and images; a power supply 19 supplying an operating voltage from a secondary battery to each unit; an autonomous-positioning control processor 20 performing autonomous positioning based on the measurement data acquired by the motion sensor including the triaxial acceleration sensor 16 and the triaxial geomagnetic sensor 15; an autonomous-positioning error-correction processor 21 correcting the position data acquired by the autonomous-positioning control processor 20; a route-data storage unit 22 accumulating a series of position data corresponding to a travelling path; a registered-point storage unit 23 storing the point data set and registered by a user; a map database 24 in which map image data of each point are registered in association with the position data; a battery cover sensor (an opening/closing detection unit) 25 that detects opening or closing of an access cover for inserting/removing the secondary battery in the power supply 19; and an operational switch 26 having a plurality of operational buttons to receive external operation instructions.

The power supply 19 includes a charging circuit (charging unit) 19a that charges the secondary battery with power from an external power source in the case where the positioning apparatus 1 is placed on a predetermined charging stage and is connected to the external power source.

In addition, the access cover on a casing can be opened to remove the secondary battery in the power supply 19 out of the positioning apparatus 1, for charging the battery with an external unit.

Such charging of the secondary battery is typically performed in a predetermined indoor environment, for example, at home.

The route-data storage unit 22 includes, for example, a RAM or a non-volatile memory.

The route-data storage unit 22 stores a series of position data as the route data acquired through continuous positioning by the positioning apparatus 1 in chronological order.

Each position data is stored together with time data indicating the acquisition time of the position data and a correction flag indicating whether the position data has already been corrected or not, for example.

The registered-point storage unit 23 includes, for example, a RAM or a non-volatile memory.

The registered-point storage unit 23 stores data of a point registered by a user as a home point.

The registered-point data include, for example, data that identifies the registered point as the home and the position data of the home point.

In the first embodiment, the registered point is the home point.

In addition to the home point, a destination to which a user is to move or a point at which a user stops off during the travelling may also be registered as the registered point, for example.

The data of such registered points are stored in the registered-point storage unit 23.

The GPS receiver 14 receives and demodulates signals from GPS satellites at predetermined time intervals via the GPS reception antenna 13 responding to an operation instruction from the CPU 10 for positioning of the current position of the positioning apparatus 1.

The GPS receiver 14 then sends the results of positioning, information on the signals transmitted from the GPS satellites, and various types of transmission data to the CPU 10.

The GPS receiver 14 functions as a first positioning unit.

The triaxial geomagnetic sensor 15 detects the direction of geomagnetism. The triaxial acceleration sensor 16 detects acceleration in each of the three axial directions.

The triaxial acceleration sensor 16 also functions as a motion detector.

The autonomous-positioning control processor 20 is a computing unit for assisting the CPU 10.

The autonomous-positioning control processor 20 acquires data, via the CPU 10, continuously sampled at a predetermined cycle, which data are measured by the triaxial geomagnetic sensor 15 and the triaxial acceleration sensor 16.

The autonomous-positioning control processor 20 calculates the moving direction and moving distance of the positioning apparatus 1 based on the measured data.

The autonomous-positioning control processor 20 adds the vector data including the calculated moving direction and moving distance to the immediately-previous position data sent from the CPU 10 to calculate position data which is a result of the autonomous positioning.

The autonomous-positioning control processor 20 sends the position data to the CPU 10.

The triaxial geomagnetic sensor 15, the triaxial acceleration sensor 16, and the autonomous-positioning control processor 20 constitute a second positioning unit.

The autonomous navigation sensors 15 and 16 and the autonomous-positioning control processor 20 of the positioning apparatus 1 of this embodiment perform autonomous positioning for, but not limited to, a walking body.

Specifically, the autonomous-positioning control processor 20 measures the number of walking steps based on intense vertical vibration appearing in the output from the triaxial acceleration sensor 16.

The autonomous-positioning control processor 20 multiplies the number of walking steps by preset stride data to measure the moving distance.

In addition, the autonomous-positioning control processor 20 analyzes large changes in acceleration in the anteroposterior direction and small changes in acceleration in the traverse direction of the walking body appearing in the output from the triaxial acceleration sensor 16.

The autonomous-positioning control processor 20 then determines the moving direction of the walking body with respect to the triaxial acceleration sensor 16.

The autonomous-positioning control processor 20 also determines a relationship between each axial direction of the triaxial acceleration sensor and the azimuth based on the geomagnetism detected by the triaxial geomagnetic sensor 15 and the direction of the gravity detected by the triaxial acceleration sensor 16.

The autonomous-positioning control processor 20 then determines the azimuth of the moving direction.

In such autonomous positioning, measurement errors of the moving distance and of the moving direction are accumulated in the position data as the results of positioning while the positioning continues.

Hence, when the position data are continuously acquired only by the autonomous positioning, the error in the position data gradually increases.

The autonomous-positioning-error correction processor 21 is a computing unit for assisting the CPU 10.

The autonomous-positioning-error correction processor 21 corrects the route data, which is calculated by the autonomous-positioning control processor 20 and stored in the route-data storage unit 22, based on accurate absolute position data acquired through the intermittent GPS positioning to acquire more accurate route data.

Such correction will be described below.

The ROM 12 holds a positioning control program for continuously storing a series of position data corresponding to a travelling path acquired through continuous autonomous positioning along with intermittent GPS positioning.

The ROM 12 also holds a display program for displaying a map image and a moving route acquired through the positioning control, on the display unit 18.

The ROM 12 further holds a point registering program for registering the home point and storing the data of the registered point into the registered-point storage unit 23 in response to an instruction input by a user.

The positioning-control program and the CPU 10 executing the program constitute a positioning control unit.

The programs are stored in the ROM 12. Alternatively, the programs may be stored in, for example, a portable storage medium, such as an optical disc; or a non-volatile memory, such as a flash memory, which can be read by the CPU 10 via a data reading device.

Such programs may also be downloaded to the positioning apparatus 1 on a carrier wave transmitted via a communication line.

The point registration is started when a user selects a home registration from a menu, for example.

In the point registration, a user slidably moves a pointer mark on a map image.

The user then operates a determination key at the timing when the pointer mark lies on the home point.

The point determined through such user operation with the pointer mark is registered as a home point.

Another registering process may be employed where a user selects a home registering menu at home, upon which the position of the home point is measured through GPS positioning, and thereby the home point is registered.

Alternatively, the home point may be registered in such a way that a user inputs numerical values representing the position data of the home point.

The CPU 10 executing the point registration and the registered-point storage unit 23 constitute a point registering unit.

### [Positioning Control]

In the positioning control, the GPS receiver 14 intermittently (for example, every 30 minutes) receives signals from the GPS satellites for GPS positioning.

In addition, the autonomous-positioning control processor 20 continuously performs autonomous positioning.

Thus, position data of each point corresponding to a travelling path are acquired, and a series of position data are recorded as the route data.

In the autonomous positioning, accurate absolute position data acquired through GPS positioning are set as position data of a start point, and the position data of each point corresponding to the travelling path are acquired by adding the data of relative displacement (a moving distance and a moving direction) calculated by the autonomous-positioning control processor 20 to the position data of the start point.

The position data of the start point to be used for the autonomous positioning are updated every time that the accurate absolute position data are acquired through the intermittent GPS positioning.

Such update of the position data of the start point resets the errors accumulated during autonomous positioning, avoiding increases in the accumulated errors.

In the positioning control, route data are corrected to more accurate route data every time the accurate absolute position data are acquired through the intermittent GPS positioning.

The correction process is performed by the autonomous-positioning-error correction processor 21 as follows.

Here, a point corresponding to the data of the accurate absolute position data acquired through the intermittent GPS positioning is expressed as a true end point, and a point corresponding to the position data acquired through autonomous positioning at the timing of the GPS positioning is expressed as an end point.

In the correction process, a locus from a start point to an end point acquired through autonomous positioning is uniformly expanded/contracted and rotated with the start point fixed so as to be similarly transformed such that the endpoint of the locus is superimposed on the true end point.

In the correction process, the route data (a series of position data) from the start point to the end point are corrected to the positions on the locus that has been expanded/contracted and rotated through the similarity transformation.

The correction process is completed with this correction.

Through such a correction process, errors, which may be uniformly included in the measured values of the moving distance and moving direction acquired by the autonomous-positioning control processor 20, are removed and thus accurate moving route data are acquired.

In addition, such a correction process makes it possible to obtain position data corresponding to continuous positions from the start to the end of positioning, even when the start point of autonomous positioning is updated upon GPS positioning.

Furthermore, the positioning control of the first embodiment includes determination of a current position based on the registered point and correction of the route data, in addition to the above-described positioning control.

Such processes are described below.

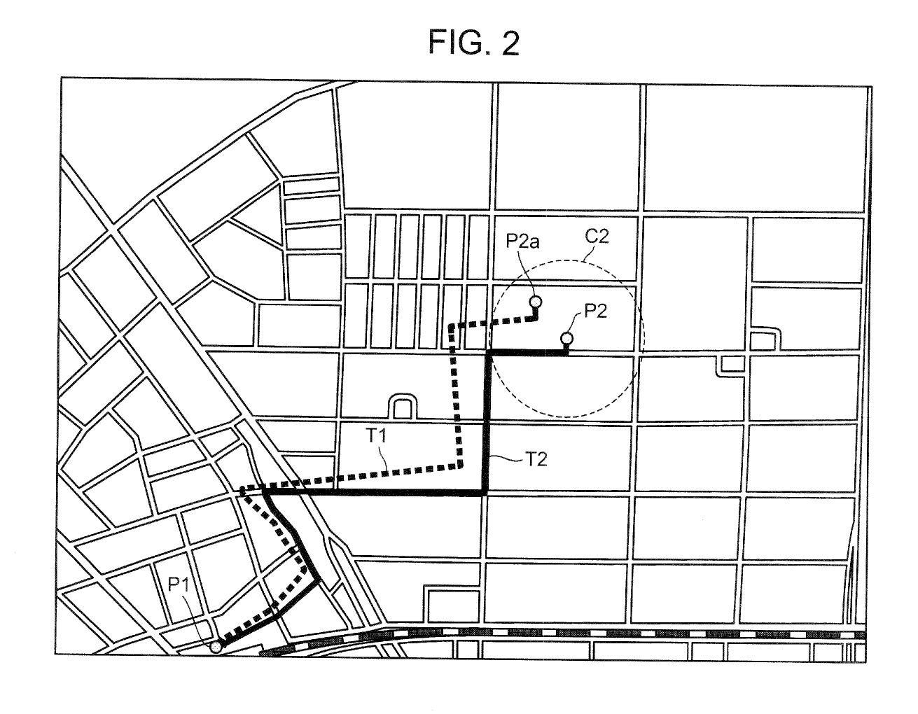

FIG. 2 illustrates an example of recording of a moving route along a path from a station to home.

In FIG. 2, P1 represents a start point for autonomous positioning, T1 represents a locus acquired through the autonomous positioning, T2 represents a corrected locus, and P2 represents a registered point of home set by a user.

In the example of FIG. 2, accurate position data is acquired through GPS positioning at the start point P1, and then autonomous positioning is continuously performed along with the movement of the user to acquire the route data represented by the locus T1.

The position data acquired through the autonomous positioning correspond to the data of estimated points at respective timings.

In the case where the estimated position measured through the autonomous positioning is within a predetermined distance (area C2: within a radius of 30 meters, for example) of the registered point P2 (i.e., home), and it is determined that the apparatus 1 is in a predetermined state indicating that a user is likely to arrive at home, the positioning apparatus 1 of the first embodiment determines that the user has arrived at the registered point P2, and determines the registered point P2 to be a point at the time.

In the first embodiment, whether the user is likely to arrive at home or not is specifically determined based on whether the following condition is satisfied or not.

That is, such state determination is made based on whether a condition that the autonomous-positioning control processor 20 detects movement of walking within a predetermined time (for example, 3 minutes) is satisfied or not.

When the condition is satisfied, it is determined that the user is likely to arrive at home. When the condition is not satisfied, it is determined that the user does not arrive at home.

Furthermore, when it is determined that the user is likely to arrive at home, the positioning apparatus 1 of the first embodiment corrects the route data (data of the locus T1 in FIG. 2) acquired through autonomous positioning from the start point to the point at the time.

Specifically, such correction includes similarity transformation where the locus T1 from the start point P1 to the end point P2a is uniformly expanded/contracted and rotated with the start point P1 fixed such that the end point of the locus is superimposed on the registered point P2.

The correction further includes a process where the route data are corrected so as to correspond to the locus T2 acquired through the similarity transformation.

In this way, the positioning apparatus 1 is determined to be in the state where the user is likely to arrive at the registered point P2. Therefore, the positioning apparatus 1 can acquire accurate data of the position at the time even when the user enters home and thus GPS positioning is unavailable.

In addition, the route data are corrected based on the registered point P2, so that the positioning apparatus 1 can acquire data of the locus T2 with reduced errors.

Furthermore, when it is determined that the user is likely to arrive at the registered point P2, position data of a start point to be used in subsequent autonomous positioning is updated to be the position data of the registered point.

Consequently, for example, the user restarts the positioning control when going out of the home next day, upon which autonomous positioning is started with the registered point P2 as the accurate position data of the start point.

Accordingly, even when the positioning apparatus 1 cannot receive GPS signals at the restart, the positioning apparatus 1 can acquire route data based on the accurate position data of the start point when the movement of waling restarts.

### [Control Process]

A control process of the above-described positioning will be described in detail below.

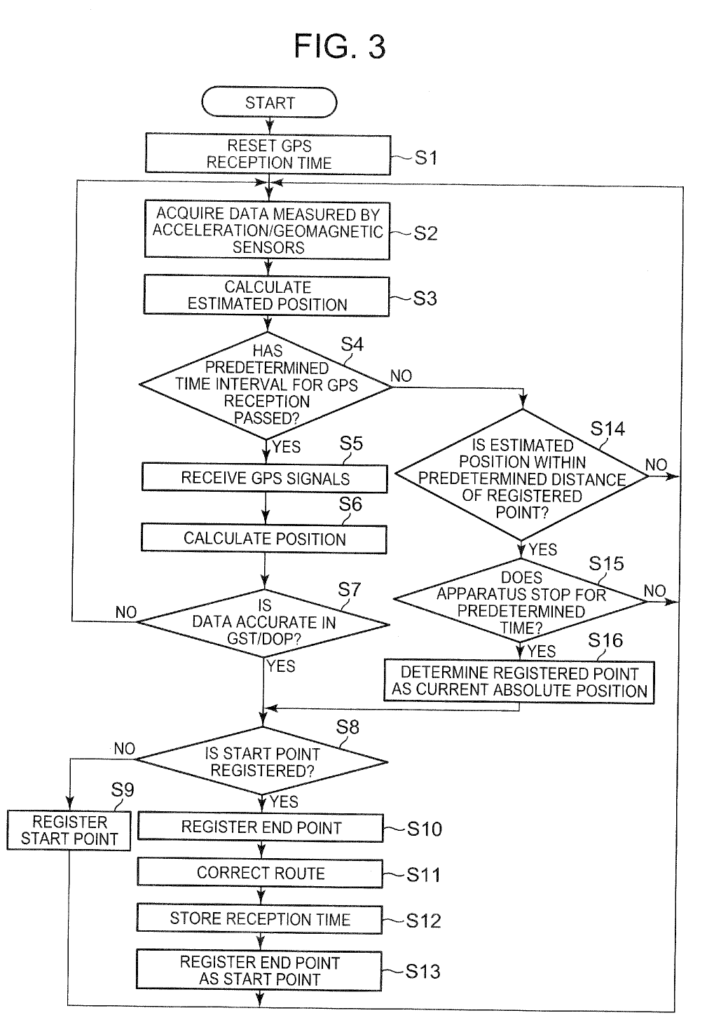

FIG. 3 is a flow chart illustrating the positioning control to be executed by the CPU 10.

Upon start of the positioning control, the CPU 10 resets the time so that intermittent GPS signal reception is preformed immediately (step S1).

Then, the CPU 10 shifts the process to a loop where the CPU 10 allows the autonomous positioning control processor 20 to perform continuous autonomous positioning and allows the GPS receiver 14 to perform intermittent GPS positioning.

In the loop, the CPU 10 allows the autonomous positioning control processor 20 to repeat steps S2 to S4 to perform continuous autonomous positioning.

Specifically, the CPU 10 acquires output from each of the triaxial geomagnetic sensor 15 and the triaxial acceleration sensor 16 (step S2).

The CPU 10 then sends such sampling data and immediately-previous position data to the autonomous positioning control processor 20 for calculation of current position data (estimated position data) (step S3: position calculation unit).

The calculated position data are stored in the route-data storage unit 22.

After the absolute position data of the start point are acquired, the CPU 10 repeats the processes of steps S2 and S3 for the continuous autonomous positioning and creates route data.

Such creation of the route data constitutes a moving-route calculation unit.

When no absolute position data exist at the start of the positioning control, the CPU 10 fails in the calculation of the position data in step S3. Thus, the CPU 10 immediately shifts the process to a step of allowing the GPS receiver 14 to perform GPS positioning to acquire the absolute position data of the start point.

When the autonomous positioning is performed without acquiring the absolute position data, the CPU 10 may allow the autonomous positioning control processor 20 to calculate relative position data expressed in the relative coordinates.

When the absolute position data are acquired later, the CPU 10 may change the calculated relative position data to position data in the absolute coordinates based on the later-acquired absolute position data.

In the loop of the positioning control, the CPU 10 allows the GPS receiver 14 to perform intermittent GPS positioning and accompanying processes in a loop of steps S4 to S8.

In the determination of step S4, the CPU 10 determines whether a predetermined reception interval (for example, a certain time from the previous reception timing) has passed or not (step S4).

When the predetermined reception interval has passed from the start of the positioning control, the CPU 10 advances the process to “YES”.

When the process is advanced to “YES”, the CPU 10 allows the GPS receiver 14 to receive GPS signals and to input the reception data to the CPU 10 (step S5).

The CPU 10 then calculates position data (first absolute position data) through predetermined positioning based on the reception data (step S6).

The CPU 10 then determines whether or not the precision of the position data is equal to or higher than a predetermined value based on the precision information acquired from the reception data (step S7).

When the precision is equal to or higher than the predetermined value, the CPU 10 advances the process to step S8.

Such precision information may be based on, for example, a dilution-of-precision (DOP) value or GNSS pseudorange error statistics (GST).

When the precision of the position data is not equal to or higher than the predetermined value as a result of the determination of step S7, the CPU 10 discards the results of GPS positioning.

The CPU 10 then returns the process to the loop of autonomous positioning beginning from step S2.

When the precision of the position data is equal to or higher than the predetermined value in the determination of step S7, the CPU 10 determines whether a start point used for the autonomous positioning is already registered or not (step S8).

When the start point is not registered, the CPU 10 registers the position data acquired through the GPS positioning as the start point (step S9).

The CPU 10 then returns the process to the loop beginning from step S2.

When the start point is registered, the CPU 10 registers the results of the immediately-previous GPS positioning as the position data of the true end point (an end point of a part of the moving route) (step S10).

The CPU 10 then allows the autonomous-positioning-error correction processor 21 to correct the route data from the start point to the end point acquired through the autonomous positioning (step S11: moving-route correction unit).

Through this correction, route data from the start point to the end point set at the time, among the route data stored in the route-data storage unit 22, are corrected and overwritten in the route-data storage unit 22.

The CPU 10 then allows the RAM 11 to store time of immediately-previous GPS signal reception to measure the next reception time (step S12).

The CPU 10 then newly registers the position data, which are previously registered as the end point, as the start point (step S13).

The CPU 10 then returns the process to step S2.

That is, the CPU 10 allows the GPS receiver 14 to perform intermittent GPS positioning in the loop of steps S4 to S8. When accurate positioning results are acquired, the CPU 10 then registers the above position data as the data of the start point or the end point of the autonomous positioning.

When the result of the GPS positioning is registered as the end point, the CPU 10 allows the autonomous-positioning-error correction processor 21 to correct the route data acquired through the autonomous positioning.

In the positioning control of FIG. 3, the CPU 10 performs a process to use the data of the registered point in steps S14 to S16.

Specifically, when the CPU 10 determines that the predetermined reception interval has not passed in step S4, it advances the process to step S14.

The CPU 10 then determines whether the current estimated position is within a predetermined distance of the registered point or not (step S14: distance determination unit).

Specifically, the CPU 10 determines whether the point of a user is close to the registered point or not.

When the estimated position is not within the predetermined distance as a result of the determination of step S14, the CPU 10 determines that the point of the user is not yet close to the registered point, and returns the process to step S2.

When the estimated position is within the predetermined distance as a result of the determination of step S14, the CPU 10 determines that the point of the user is close to the registered point, and advances the process to step S15.

The CPU 10 then checks the results of analysis of movement of walking obtained by the autonomous positioning control processor 20 from a predetermined time earlier (for example, 3 minutes earlier) to the current time to determine whether or not movement of walking is stopped for the predetermined time, and determines that the user is likely to arrive at home (step S15: arrival determination unit).

When movement of walking is detected within the predetermined time as a result of the determination of step S15, the CPU 10 determines that the user is still moving on the way to the home, and returns the process to step S2.

When movement of walking is not detected within the predetermined time as a result of the determination of step S15, the CPU 10 determines that the user has arrived at the registered point, and determines the position data (second absolute position data) of the registered point to be the current absolute position data (step S16: current-position determination unit).

The CPU 10 then advances the process to step S8.

After advancing the process to step S8, the CPU 10 registers the position data of the registered point as the start point or the end point of the autonomous positioning, as described before.

When the position data are registered as the end point, the CPU 10 allows the autonomous-positioning-error correction processor 21 to correct the route data.

The CPU 10 determines that the user has arrived at the registered point through such processes of steps S14 to S16, and determines the preset accurate position data of the registered point to be current absolute position data.

Furthermore, the CPU 10 allows the autonomous-positioning-error correction processor 21 to correct previously-acquired route data, when such data exists, to record accurate route data.

After the CPU 10 determines that the user returns to the registered point (for example, home) and determines the point based on the position data of the registered point, the CPU 10 registers the position data of the registered point as the start point through the process of step S13.

Accordingly, when the user leaves home with the positioning apparatus 1 again, the CPU 10 allows the autonomous positioning control processor 20 to start creating route data from the start point at which the position data of the registered point is registered.

For example, when the positioning apparatus 1 is not operated for a predetermined time since the user arrives at home, or the CPU 10 does not receive data from the triaxial acceleration sensor 16 for a predetermined time, the CPU 10 shifts the positioning apparatus 1 to a sleep mode as a power saving state.

If the user goes out next day, the CPU 10 cancels the sleep mode through user operation or upon a signal input from the triaxial acceleration sensor 16 to restart the positioning control.

In such a case, the CPU 10 also allows the autonomous positioning control processor 20 to start autonomous positioning with the position data of the registered point set as the start point.

Hence, even when the CPU 10 fails in intermittent GPS signal reception after the sleep mode is canceled, the start point is accurately set based on the position data of the registered point.

Consequently, the positioning apparatus 1 can create and record the route data based on the accurate position data of the start point from restart of the positioning control.

As described hereinbefore, according to the positioning apparatus 1 of the first embodiment, the user beforehand registers the home point as the registered point.

In the case where the CPU 10 determines that the estimated position acquired through the autonomous positioning is within a predetermined distance of the registered point and the user is likely to arrive at home, the positioning apparatus 1 determines the position data of the registered point to be the current absolute position data.

This can prevent the positioning apparatus 1 from reaching wrong positioning results when the user arrives at the registered point.

In the positioning apparatus 1 of the first embodiment, the CPU 10 determines whether the user has arrived at the registered point through two determination steps: one is the determination of whether the user is close to the registered point in step S14, and the other is the determination of whether the user is likely to arrive at home in step S15.

Consequently, the CPU 10 can accurately determine the arrival of the user at the registered point.

Furthermore, the CPU 10 does not perform useless state determination in step S16, leading to a reduction in loads on the CPU 10.

In the positioning apparatus 1 of the first embodiment, in the case where the CPU 10 determines that the user has arrived at the registered point and determines the position data of the registered point to be the positioning result at the time, the CPU 10 allows the autonomous-positioning-error correction processor 21 to correct the previously-acquired route data based on the position data.

Consequently, the CPU 10 can record accurate route data at the registered point.

In the case where the user arrives at the registered point and then moves from the point, the CPU 10 allows the autonomous positioning control processor 20 to start autonomous positioning with the position data of the registered point set as the start point.

Consequently, even when the CPU 10 cannot immediately receive GPS signals when the user starts moving from the registered point, the CPU 10 can allow the processor 20 to start the autonomous positioning with the registered point, whose position data are accurately known, being set as an accurate position of the start point.

In the first embodiment, the predetermined distance, which is a threshold value for determining whether the user is close to the registered point or not in step S14, is fixed.

Since errors are gradually accumulated in the autonomous positioning, the predetermined distance as the threshold value for the determination may be changed depending on a linear distance from the start point or a cumulative distance of the moving route from the start point (such that the threshold value is increased as the linear distance/cumulative distance increases).

### Second Embodiment

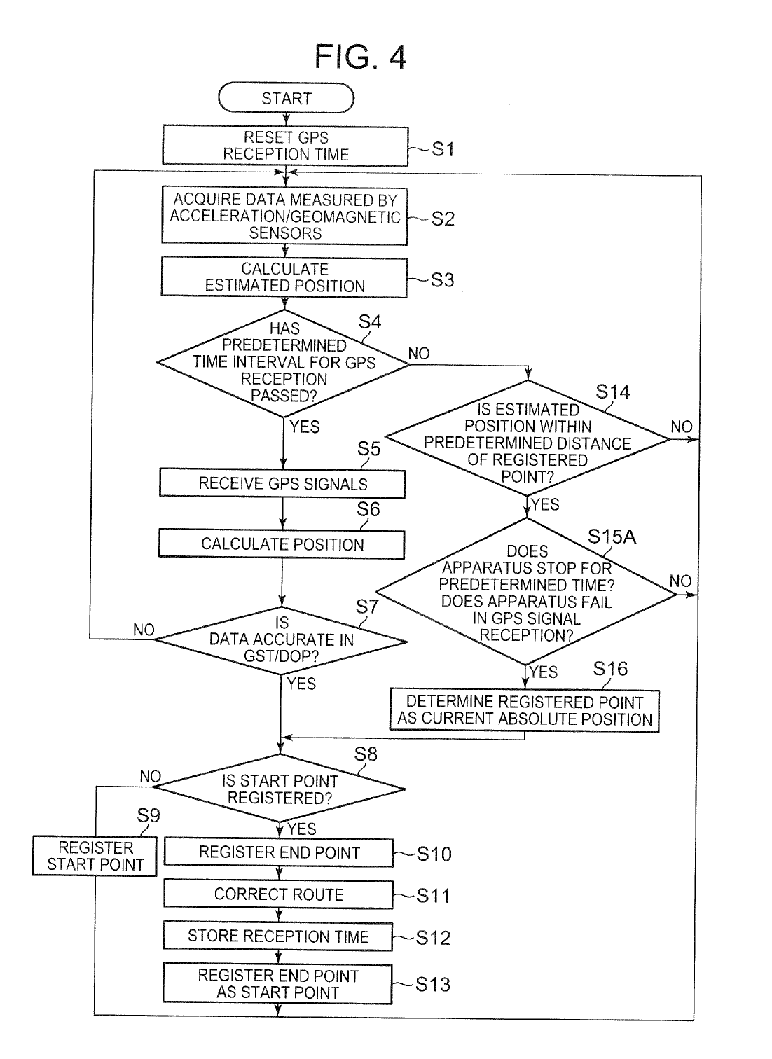

FIG. 4 is a flow chart illustrating the positioning control to be executed by the CPU 10 in a second embodiment.

The second embodiment is the same as the first embodiment except that the positioning control is partially different from that in the first embodiment.

The following description is focused on the difference.

The steps of the positioning control in the second embodiment are the same as those of the positioning control shown in FIG. 3 except for the condition for determining the likelihood of arrival of the user at home in step S15A, as shown in FIG. 4.

In the second embodiment, when the CPU 10 determines that the current estimated position is within a predetermined distance of the registered point in step S14, the CPU 10 then checks the results of analysis of movement of walking obtained by the autonomous positioning control processor 20 from a predetermined time earlier (for example, 3 minutes earlier) to the current time.

The CPU 10 then determines whether movement of walking is stopped for the predetermined time, and determines whether the CPU 10 fails in immediately-previous GPS signal reception executed in step S5 by the predetermined number of times (for example, once or twice) (step S15A: arrival determination unit).

In step S15A, when the CPU 10 determines that movement of walking is stopped for the predetermined time, the CPU 10 may perform GPS signal reception to determine whether the CPU 10 fails in the signal reception or not.

When the CPU 10 determines that both of the following two conditions are satisfied, the CPU 10 determines that the user has arrived at home and shits the process to step S16. That is, one of the conditions is that movement of walking is stopped for the predetermined time, and the other is that the CPU 10 fails in the GPS signal reception.

When one of the conditions is not satisfied, the CPU 10 determines that the user does not arrive at the registered point, and returns the process to step S2.

In each case, the positioning control identical to that in the first embodiment is performed thereafter.

According to the positioning apparatus 1 of the second embodiment, when movement of walking is not detected for the predetermined time, and the CPU 10 fails in GPS signal reception, the CPU 10 determines that the user is likely to arrive at home.

Hence, even when an indoor point where GPS signals do not reach is set as the registered point, the positioning apparatus 1 can accurately determine that the user has arrived at the registered point.

In addition, even when the user is located in any place other than the home, such as a shop in a shopping mall or a room in a hotel linked to an underground mall, the positioning apparatus 1 can correctly determine that the user has arrived at the registered point by setting a point, where GPS signals become unavailable relatively long before the arrival, as the registered point.

As a modification of the second embodiment, the CPU 10 may determine the high likelihood of arrival of the user at the registered point only under a condition that the current estimated position is within a predetermined distance of the registered point, and that the CPU 10 fails in GPS signal reception.

In such a case, the positioning apparatus 1 determines a user's arrival at the destination when GPS signals become unavailable. More specifically, in the case where home is set as the registered point, for example, GPS signals are available until the user arrives at home. However, the GPS signals become unavailable at the timing when the user goes inside the home. The positioning apparatus 1 judges this timing as the user's arrival at home. Thus, the positioning apparatus 1 according to the modification of the second embodiment can accurately determine that the user has arrived at the destination.

The condition that no movement of walking is detected for a predetermined time, which is one of the conditions for determining the arrival of the user at the registered point in the first and second embodiments, can be modified into a condition that the positioning apparatus 1 is at rest for a predetermined time (the positioning apparatus 1 is placed somewhere) based on output from the triaxial acceleration sensor 16.

Alternatively, the condition that no movement of walking is detected for a predetermined time can be modified into a condition that a moving distance in a predetermined period is within a certain distance (for example, within 5 meters), considering that the user moves in a small range within the registered point after arrival at the registered point.

Through such modifications, the positioning apparatus 1 can accurately determine the arrival of the user at the registered point in a particular use situation.

### Third Embodiment

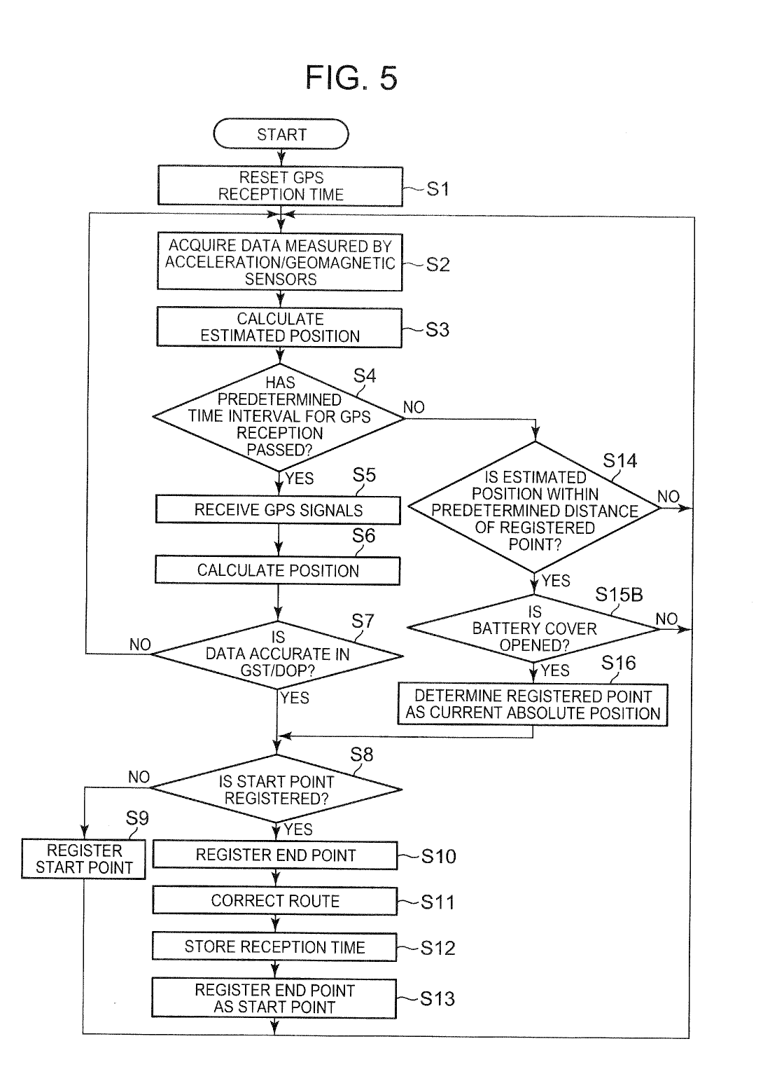

FIG. 5 is a flow chart illustrating the positioning control to be executed by the CPU 10 in a third embodiment.

The third embodiment is identical to the first embodiment except that the positioning control is partially different from that in the first embodiment.

The following description is focused on the difference.

The steps of the positioning control in the third embodiment are the same as those of the positioning control shown in FIG. 3 except for step S15B for determining the likelihood of arrival of the user at home, as shown in FIG. 5.

In the third embodiment, when the CPU 10 determines that the current estimated position is within a predetermined distance of the registered point in step S14, the CPU 10 then determines whether a battery cover is opened or not based on output from the battery cover sensor 25 (step S15B: arrival determination unit).

When the CPU 10 determines that the battery cover is opened, it determines that the user has arrived at home and opened the battery cover to charge the battery. The CPU 10 then shifts the process to step S16.

When opening of the battery cover is not detected, the CPU 10 returns the process to step S2.

In each case, the positioning control identical to that in the first embodiment is performed thereafter.

According to the positioning apparatus 1 of the third embodiment, the CPU 10 determines that opening of the battery cover indicates a high likelihood of the arrival of the user at home.

Hence, when a point, such as home where the battery can be charged, is set as the registered point, the positioning apparatus 1 can accurately determines that the user has arrived at the registered point.

As a modification of the third embodiment, in the case of a positioning apparatus 1 whose battery is to be charged when the positioning apparatus 1 is placed on a charging stage, the CPU 10 may determine that the user is likely to arrive at the registered point when the CPU 10 detects starting of the battery charging based on detection of operation of the charging circuit 19a.

According to such a configuration, the positioning apparatus 1 can also accurately determine the arrival of the user at the registered point where the battery can be charged, such as home.

### Fourth Embodiment

The fourth embodiment is identical to the first embodiment except that the positioning control is partially different from that in the first embodiment.

The following description is focused on the difference.

Instead of using the position data of the registered point when the CPU determines that a user has arrives at home as in the first to third embodiments, the positioning apparatus 1 of the fourth embodiment performs GPS positioning before GPS signals become unavailable owing to a user's arrival at the registered point (for example, home), and thereby, the positioning apparatus 1 of the fourth embodiment can improve accuracy in positioning data in the neighborhood of the registered point.

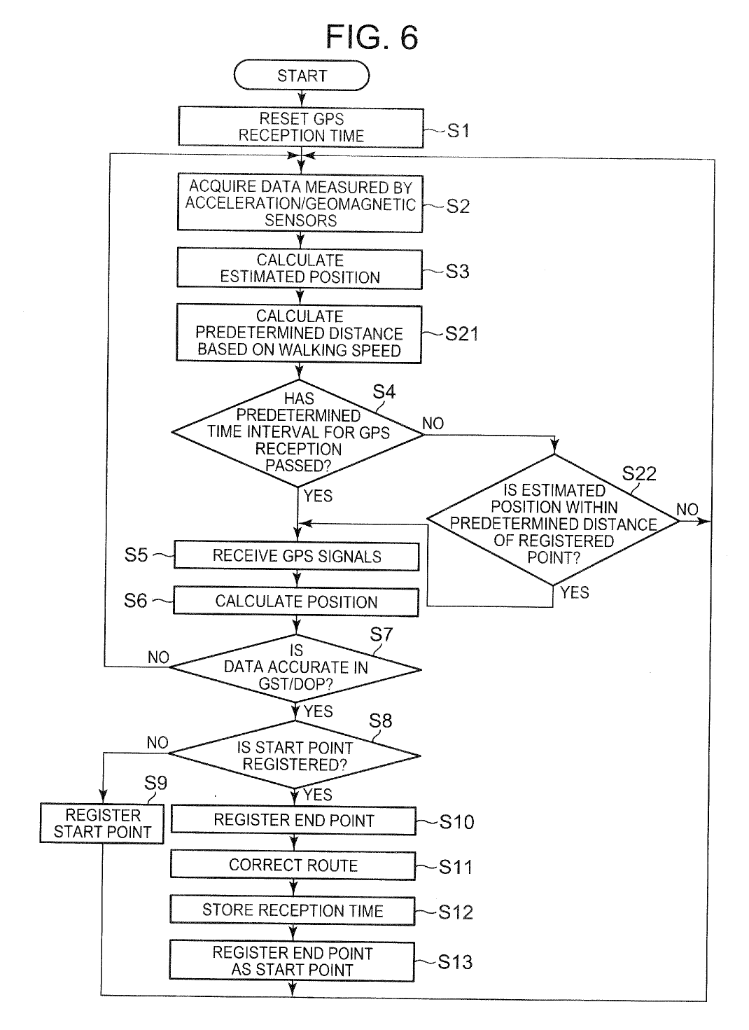

In the positioning control of the fourth embodiment, steps S21 and S22 shown in FIG. 6 are different from those in the first embodiment, but step S1 to step S13 are the same as those in the first embodiment shown in FIG. 3.

In the fourth embodiment, when the CPU 10 determines that the intermittent GPS-signal reception interval has not passed in step S4, the CPU 10 then determines whether the current estimated position is within a predetermined distance of the registered point or not (step S22).

The predetermined distance employed in step 22 in the fourth embodiment is different from the predetermined distance in step S14 (FIG. 3) in the first embodiment in that predetermined distance of the fourth embodiment is set within which GPS positioning can be performed before a user's arrival at the registered point.

When the CPU 10 determines that the current estimated position is within the predetermined distance in the determination of step S22, the CPU 10 then determines that the user is at a point just before arriving at the registered point, and shifts the process to step S5 to allow the GPS receiver 14 to receive GPS signals even when the intermittent reception interval has not passed.

After that, the positioning control is continued as in the first embodiment.

In the positioning control of the fourth embodiment, the CPU 10 sets the predetermined distance, which is a threshold value for the determination, to an appropriate value in step S21 so as to appropriately determine the timing just before the user's arrival at the registered point in the determination of step S22.

The process of step S21 is performed in conjunction with the continuously-repeated autonomous positioning (steps S2 and S3).

When a set of autonomous positioning processes is performed in steps S2 and S3, the CPU 10 then calculates the walking speed based on the results of the continuous autonomous positioning, and sets the predetermined distance such that the distance is lengthened as the walking speed increases or is reduced as the walking speed decreases (step S21).

In the case where the moving distance is calculated by multiplying the number of steps by a certain stride in the autonomous positioning, the walking speed is determined based on a time interval of walking in each step.

In the case where the moving distance is calculated while an estimated stride is changed depending on a magnitude of vertical acceleration in each step, the walking speed is determined in consideration of such a change in stride.

The autonomous positioning control processor 20 that calculates the walking speed in this way functions as a speed calculation unit.

As described hereinbefore, according the positioning apparatus 1 of the fourth embodiment, when the estimated position acquired through the autonomous positioning is within a predetermined distance of the registered point, the positioning apparatus 1 performs GPS positioning even when the intermittent GPS-signal reception interval has not passed.

As a result, the positioning apparatus 1 can avoid reaching wrong positioning results in the neighborhood of the registered point, such as home, by performing the GPS positioning before GPS signals become unavailable owing to a user's arrival at the registered point.

In addition, the predetermined distance, which is the threshold value for determination of whether to perform GPS positioning, varies depending on the walking speed.

Consequently, the positioning apparatus 1 can appropriately determine the timing just before arrival of the user at the registered point regardless of the walking speed to perform the GPS positioning at the timing.

The predetermined distance may be changed with various parameters including the distance from the start point set at the time or a moving distance from the start point, instead of charging the distance based on the walking speed alone, so that the timing just before arrival of the user at the registered point can be more appropriately determined.

The present invention is not limited to the first to fourth embodiments described above, and can include various modifications.

For example, while home is employed as the registered point herein, a destination or a pass-through point may be registered.

Alternatively, a plurality of points such as the destination, the home point, and the pass-through point may be registered instead of registering only one point. This provides the same advantage that results of positioning do not largely deviate from the right positions in the neighborhood of the registered point.

In the embodiments described above, the predetermined state, which indicates that a user is likely to arrive at the registered point, is automatically determined. Instead, a user may operate an arrival-indicating button at the timing of arrival at the registered point so that the button operation is determined to be the predetermined state indicating the likelihood of the arrival.

In the embodiments described above, the intermittent GPS positioning is performed at predetermined time intervals. Instead, the timing of the intermittent GPS positioning may be determined with other parameters such as the moving distance.

In addition, the positioning satellites are not limited to the GPS satellites.

In addition, the autonomous positioning is not limited to the autonomous positioning intended for walking, and autonomous positioning for vehicle running may be employed, for example.

In addition, the method of correcting the route data is not limited to that described in the embodiments.

The detailed configuration and methods described in the embodiments maybe changed appropriately without departing from the scope of the invention.

While several embodiments of the invention have been described, the scope of the invention is not limited to the embodiments, and includes the scope of the claimed invention and the equivalents thereof.

The entire disclosure of Japanese Patent Application No. 2011-032830 filed on Feb. 18, 2011 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A positioning apparatus comprising:
a first positioning unit that acquires first absolute position data by receiving signals from positioning satellites at predetermined time intervals to measure a current position of the positioning apparatus;
a second positioning unit that continuously detects a movement and a traveling direction of the positioning apparatus, and acquires relative position data based on the movement and the traveling direction;
a position calculation unit that calculates a current estimated position of the positioning apparatus based on the first absolute position data and the relative position data;
a point registration unit that registers a point as second absolute position data;
a distance determination unit that determines whether the estimated position calculated by the position calculation unit is within a predetermined distance of the point registered by the point registration unit;
an arrival determination unit that determines whether the positioning apparatus is in a predetermined state, the predetermined state indicating that the positioning apparatus is likely to arrive at the registered point; and
a current-position determination unit that determines the second absolute position data to be current absolute position data when the distance determination unit determines that the estimated position is within the predetermined distance of the registered point and when the arrival determination unit determines that the positioning apparatus is in the predetermined state.

2. The positioning apparatus according to claim 1, further comprising a motion detection unit that detects motion of the positioning apparatus,
wherein the arrival determination unit determines that the positioning apparatus is in the predetermined state when the motion detection unit detects no motion for a predetermined period and/or when the first positioning unit fails to acquire the first absolute position data.

3. The positioning apparatus according to claim 1,
wherein the arrival determination unit determines that the positioning apparatus is in the predetermined state when the current estimated position of the positioning apparatus sequentially calculated by the position calculation unit remains within a predetermined range for a predetermined period and/or when the first positioning unit fails to acquire the first absolute position data.

4. The positioning apparatus according to claim 1, further comprising a charging unit that acquires power from an external power source for charging,
wherein the arrival determination unit determines that the positioning apparatus is in the predetermined state when the charging unit starts charging.

5. The positioning apparatus according to claim 1, further comprising:
a battery cover that is opened for a battery to be put in or removed from the positioning apparatus,
an opening/closing detection unit that detects opening or closing of the battery cover,
wherein the arrival determination unit determines that the positioning apparatus is in the predetermined state when the opening/closing detection unit detects the opening of the battery cover.

6. The positioning apparatus according to claim 1, further comprising:
a moving-route calculation unit that calculates a moving route based on the first absolute position data and the relative position data, and
a moving-route correction unit that corrects the moving route based on the first absolute position data,
wherein, when the current-position determination unit determines the second absolute position data to be the current absolute position data, the moving-route correction unit corrects the moving route based on the second absolute position data in addition to the first absolute position data.

7. The positioning apparatus according to claim 6,
wherein the moving-route calculation unit calculates the moving route by adding the relative position data to the first absolute position data, and
when the current-position determination unit determines the second absolute position data to be the current absolute position data, the moving-route calculation unit calculates the moving route using the second absolute position data.

8. A positioning apparatus comprising:
a first positioning unit that acquires first absolute position data by receiving signals from positioning satellites at predetermined time intervals to measure a current position of the positioning apparatus;
a second positioning unit that continuously detects a movement and a traveling direction of the positioning apparatus, and acquires relative position data based on the movement and the traveling direction;
a positioning control unit that allows the first positioning unit to acquire the first absolute position data, and allows the second positioning unit to acquire the relative position data;
a position calculation unit that calculates a current estimated position of the positioning apparatus based on the first absolute position data and the relative position data;
a point registration unit that registers a point;
a distance determination unit that determines whether the estimated position calculated by the position calculation unit is within a predetermined distance of the point registered by the point registration unit,
wherein the positioning control unit allows the first positioning unit to acquire the first absolute position data when the distance determination unit determines that the estimated position is within the predetermined distance.

9. The positioning apparatus according to claim 8, further comprising a speed calculation unit that calculates moving speed based on the detected movement,
wherein the predetermined distance is changed depending on the moving speed calculated by the speed calculation unit.

10. A positioning method using a first positioning unit and a second positioning unit, the first positioning unit acquiring first absolute position data by receiving signals from positioning satellites at predetermined time intervals to measure a current position of a positioning apparatus, and the second positioning unit continuously detecting a movement and a traveling direction of the positioning apparatus to acquire relative position data based on the movement and the traveling direction, the method comprising:
(a) calculating a current estimated position of the positioning apparatus based on the first absolute position data and the relative position data;
(b) registering a point as second absolute position data;
(c) determining whether the estimated position calculated by step (a) is within a predetermined distance of the point registered by step (b);
(d) determining whether the positioning apparatus is in a predetermined state, the predetermined state indicating that the positioning apparatus is likely to arrive at the registered point; and
(e) determining the second absolute position data to be current absolute position data when step (c) determines that the estimated position is within the predetermined distance of the registered point and when step (d) determines that the positioning apparatus is in the predetermined state.

11. The positioning method according to claim 10, further comprising:
(f) calculating a moving route based on the first absolute position data and the relative position data, and
(g) correcting the moving route based on the first absolute position data,
wherein, when step (e) determines the second absolute position data to be the current absolute position data, step (g) corrects the moving route based on the second absolute position data in addition to the first absolute position data.

12. A positioning method using a first positioning unit and a second positioning unit, the first positioning unit acquiring first absolute position data by receiving signals from positioning satellites at predetermined time intervals to measure a current position of a positioning apparatus, and the second positioning unit continuously detecting a movement and a traveling direction of the positioning apparatus to acquire relative position data based on the movement and the traveling direction, the method comprising:
(a) allowing the first positioning unit to acquire the first absolute position data, and allowing the second positioning unit to acquire the relative position data;
(b) calculating a current estimated position of the positioning apparatus based on the first absolute position data and the relative position data;
(c) registering a point;
(d) determining whether the estimated position calculated by step (b) is within a predetermined distance of the point registered by step (c),
wherein the positioning control unit allows the first positioning unit to acquire the first absolute position data when step (d) determines that the estimated position is within the predetermined distance.

13. A computer readable storage medium having recorded thereon a computer program for controlling a computer which controls a first positioning unit and a second positioning unit, the first positioning unit acquiring first absolute position data by receiving signals from positioning satellites at predetermined time intervals to measure a current position of a positioning apparatus, and the second positioning unit continuously detecting a movement and a traveling direction of the positioning apparatus to acquire relative position data based on the movement and the traveling direction, wherein the program controls the computer to function as:
a position calculation unit that calculates a current estimated position of the positioning apparatus based on the first absolute position data and the relative position data;
a point registration unit that registers a point as second absolute position data;
a distance determination unit that determines whether the estimated position calculated by the position calculation unit is within a predetermined distance of the point registered by the point registration unit;
an arrival determination unit that determines whether the positioning apparatus is in a predetermined state, the predetermined state indicating that the positioning apparatus is likely to arrive at the registered point; and
a current-position determination unit that determines the second absolute position data to be current absolute position data when the distance determination unit determines that the estimated position is within the predetermined distance of the registered point and when the arrival determination unit determines that the positioning apparatus is in the predetermined state.

14. The storage medium storing the program according to claim 13, wherein the program further controls the computer to function as:
a moving-route calculation unit that calculates a moving route based on the first absolute position data and the relative position data, and
a moving-route correction unit that corrects the moving route based on the first absolute position data,
wherein the program further controls the computer so that, when the current-position determination unit determines the second absolute position data to be the current absolute position data, the moving-route correction unit corrects the moving route based on the second absolute position data in addition to the first absolute position data.

15. A computer readable storage medium having recorded thereon a computer program for controlling a computer which controls a first positioning unit and a second positioning unit, the first positioning unit acquiring first absolute position data by receiving signals from positioning satellites at predetermined time intervals to measure a current position of a positioning apparatus, and the second positioning unit continuously detecting a movement and a traveling direction of the positioning apparatus to acquire relative position data based on the movement and the traveling direction, wherein the program controls the computer to function as:
a positioning control unit that allows the first positioning unit to acquire the first absolute position data, and allows the second positioning unit to acquire the relative position data;
a position calculation unit that calculates a current estimated position of the positioning apparatus based on the first absolute position data and the relative position data;
a point registration unit that registers a point;
a distance determination unit that determines whether the estimated position calculated by the position calculation unit is within a predetermined distance of the point registered by the point registration unit,
wherein the program further controls the computer so that the positioning control unit allows the first positioning unit to acquire the first absolute position data when the distance determination unit determines that the estimated position is within the predetermined distance.
